(19) United States
(12) Patent Application Publication
(10) Pub. No.: US 2009/0129837 A1
(43) Pub. Date: May 21, 2009

(54) DEVELOPING DEVICE USING RECYCLED TONER

(75) Inventors: Tetsuo Kato, Kanagawa (JP); Takashi Ikeda, Shizuoka (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/255,339

(22) Filed: Oct. 21, 2008

Related U.S. Application Data
(60) Provisional application No. 60/988,336, filed on Nov. 15, 2007.

(51) Int. Cl. G03G 21/00

(52) U.S. Cl. 399/359

(57) ABSTRACT

According to an embodiment of the present invention, a ratio of a recycled toner in a first developer is detected by an auto toner sensor for recycled toner. The carrying speed of a recycled toner mixer is controlled according to a detection result. Consequently, when recycled toner density in a recycled-toner carrying chamber increases, the recycled toner mixer is rotated at high speed to discharge the recycled toner from the recycled-toner carrying chamber at high speed.

### CROSS-REFERENCE TO RELATED APPLICATION

This application is based upon and claims the benefit of priority from provisional U.S. Patent Application No. 60/988,336 filed on Nov. 15, 2007, the entire contents of which are incorporated herein by reference.

### TECHNICAL FIELD

The present invention relates to a developing device that is used in a copying machine, a printer, and the like having plural image forming speeds and performs development using a recycled toner collected from a photoconductive member.

### BACKGROUND

In an image forming apparatus such as a copying machine or a printer, as a developing device that uses a two-component developer, there is a device that supplies a collected recycled toner and reuses the recycled toner. An amount of recycled toner collected from a photoconductive member and the like of the image forming apparatus fluctuates according to switching of image forming speed, shading of an image, and the like.

In the developing device, a ratio of a recycled toner in a recycled developer is changed according to the fluctuation in the amount of recycled toner. In general, when a toner ratio of a developer fluctuates, charging performance of a toner fluctuates. Therefore, when the amount of recycled toner increases, it is likely that charging performance of the recycled toner falls.

Therefore, as a developing device that uses a recycled toner, there is a demand for the development of a developing device that can reduce fluctuation in a ratio of the recycled toner in a recycled developer and obtain stable charging performance regardless of a supply amount of the recycled toner.

### SUMMARY

An aspect of the present invention is to obtain desired charging performance of a recycled toner even when a supply amount of the recycled toner increases.

According to an aspect of the present invention, a developing device includes a developing roller opposed to an image bearing member having an electrostatic latent image formed thereon, a first toner carrying unit that carries a first developer containing a recycled toner collected from the image bearing member and a carrier in a first direction, a second toner carrying unit that carries a second developer containing a fresh toner and a carrier in a second direction, a developer supplying unit that agitates the first developer and the second developer and supplies the agitated developer to the developing roller, and a control unit that controls carrying speed of the first toner carrying unit.

### DESCRIPTION OF THE DRAWINGS

FIG. 1 is a schematic structural diagram showing an image forming apparatus according to a first embodiment of the present invention;

FIG. 2 is a schematic partial perspective view showing a cleaning device and a developing device according to the first embodiment;

FIG. 3 is a schematic explanatory diagram of the internal structure of the developing device according to the first embodiment viewed from above;

FIG. 4 is a schematic explanatory view of the internal structure of the developing device according to the first embodiment viewed from a side;

FIG. 5 is a block diagram showing a control system of a printer according to the first embodiment;

FIG. 6 is a flowchart showing an example of the control of a recycled toner mixer according to the first embodiment; and

FIG. 7 is a flowchart showing an example of the control of a recycled toner mixer according to a second embodiment of the present invention.

### DETAILED DESCRIPTION

A first embodiment of the present invention is explained in detail below with reference to the accompanying drawings.

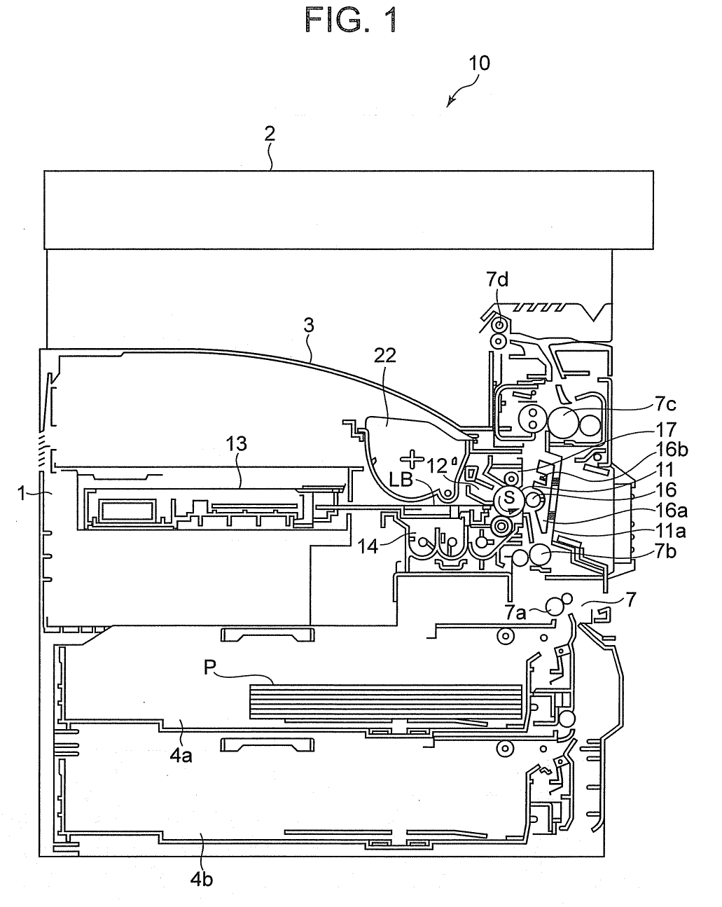

FIG. 1 is a schematic structural diagram showing an image forming apparatus 10 according to the first embodiment. The image forming apparatus 10 can form an image by switching, for example, two process speeds, i.e., first process speed and high second process speed. As the switching of the process speeds, for example, a user may select any one of the process speeds on a control panel 8. Alternatively, it is also possible to switch the process speeds, for example, by setting whether image formation is monochrome image formation or color image formation.

The image forming apparatus 10 includes a scanner unit 2 and an intra-body paper discharging unit 3 above a printer unit 1. The printer unit 1 includes a photoconductive drum 11 serving as an image bearing member that is rotated in an arrow s direction. An electrifying charger 12 that uniformly charges the photoconductive drum 11 to, for example, about −500 V, a developing device 14, a transfer roller 16 as a transfer unit, and a cleaning device 17 as a cleaning unit are arranged around the photoconductive drum 11 along a rotating direction of the photoconductive drum 11. Exposure light LB from a laser exposing device 13 is irradiated on a section between the electrifying charger 12 and the developing device 14 around the photoconductive drum 11.

The transfer roller 16 is formed by providing a rubber layer on a metal roller. The transfer roller 16 is supported by a guide member 16a swingably attached to a side cover 1a of the printer unit 1. The transfer roller 16 and the photoconductive drum 11 form a desired nip by being supported by the guide member 16a. The transfer roller 16 is constant-current controlled. An output current from the transfer roller 16 to the photoconductive drum 11 side is set to, for example, +18 μA to +32 μA. A toner image on the photoconductive drum 11 is transferred onto sheet paper P that passes through the nip. The sheet paper P having the toner image transferred thereon is peeled off by a peeling charger 16b. A whisker of the peeling charger 16b is set to peeling power of −2 μA to −6 μA. The toner image on the photoconductive drum 11 may be transferred onto the sheet paper P by using a transfer charger instead of the transfer roller 16.

A toner hopper 22 as a fresh-toner supplying unit that stores a fresh toner to be supplied to the developing device 14 is provided above the developing device 14. Paper feeding cassettes 4a and 4b that feed the sheet paper P as a recording medium in a direction of the transfer roller 16 are provided below the printer unit 1. The sheet paper P is conveyed in a direction of the nip between the photoconductive drum 11 and the transfer roller 16 via a conveying system 7. The conveying system 7 includes a conveying roller pair 7a, a registration roller pair 7b, a fixing roller pair 7c, and a paper discharge roller pair 7d.

An image forming process is started at, for example, process speed selected on the control panel 8. When the process speed of the image forming apparatus 10 is switched, the driving speed of the conveying system 7, the photoconductive drum 11, the developing device 14, and the cleaning device 17 is switched. The photoconductive drum 11 rotates in the arrow s direction at predetermined process speed. An electrostatic latent image is formed on the photoconductive drum 11 through a charging process and an exposure process according to the rotation. Subsequently, a toner image is formed on the photoconductive drum 11 through a development process. The toner image on the photoconductive drum 11 is brought into contact with and transferred onto the sheet paper P that passes through the nip between the photoconductive drum 11 and the transfer roller 16. The toner image is completed on the sheet paper P having the toner image transferred thereon through a fixing process. After the toner image is transferred, a residual toner is removed from the photoconductive drum 11 by the cleaning device 17 and the photoconductive drum 11 is prepared for the next image formation.

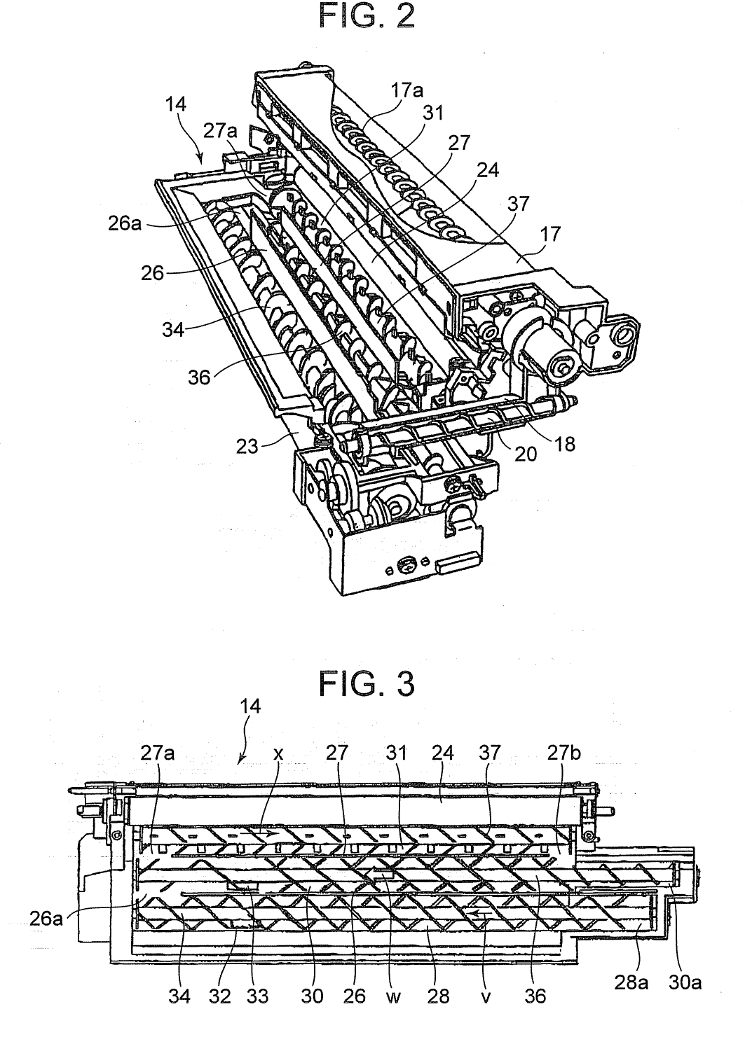

The developing device 14 is explained in detail with reference to FIGS. 2 to 6. The developing device 14 performs development using a recycled toner removed from the photoconductive drum 11 by the cleaning device 17. The cleaning device 17 collects a toner on the photoconductive drum 11 using an existing cleaning blade, cleaning brush, or the like. The collected recycled toner is carried to a collecting mechanism 18 serving as a recycled-toner supplying unit by a cleaner auger 17a shown in FIG. 2. The collecting mechanism 18 supplies the recycled toner to the developing device 14 using a collection auger 20.

A developing roller 24 is rotatably provided in a case 23 as a developing device main body of the developing device 14. The developing roller 24 is opposed to the photoconductive drum 11 and supplies a toner to an electrostatic latent image formed on the photoconductive drum 11. The inside of the case 23 is partitioned along an axial direction of the photoconductive drum 11 by a first partition plate 26 and a second partition plate 27. The inside of the case 23 is partitioned into a recycled-toner carrying chamber 28, a fresh-toner carrying chamber 30, and an agitating and supplying chamber 31. A recycled-toner supply port 28a is formed on a front side of the recycled-toner carrying chamber 28. A fresh-toner supply port 30a is formed on a front side of the fresh-toner carrying chamber 30.

The recycled toner carried by the collecting mechanism 18 is supplied into the recycled-toner carrying chamber 28 from the recycled-toner supply port 28a. The fresh toner in the toner hopper 22 is supplied into the fresh-toner carrying chamber 30 from the fresh-toner supply port 30a. A cut-out first communicating section 26a is formed at a rear side end of the first partition plate 26. A cut-out second communicating section 27a is formed at a rear side end of the second partition plate 27. A cut-out third communicating section 27b is formed at a front side end of the second partition plate 27.

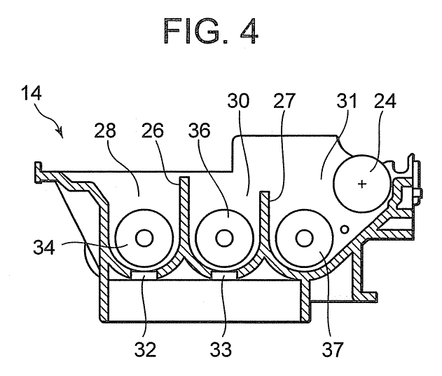

As shown in FIGS. 3 and 4, an auto toner sensor for recycled toner 32 serving as a toner-ratio detecting unit is provided in the recycled-toner carrying chamber 28. The auto toner sensor for recycled toner 32 detects a ratio of a recycled toner in a first developer containing the recycled toner and a carrier. An auto toner sensor for fresh toner 33 is provided in the fresh-toner carrying chamber 30. The auto toner sensor for fresh toner 33 detects a ratio of a fresh toner in a second developer containing the fresh toner and a carrier. When a toner ratio detected by the auto toner sensor for fresh toner 33 falls below a predetermined value, the fresh toner in the toner hopper 22 is supplied from the fresh-toner supply port 30a.

A recycled toner mixer 34 as a first toner carrying unit is provided in the recycled-toner carrying chamber 28. A fresh toner mixer 36 as a second toner carrying unit is provided in the fresh-toner carrying chamber 30. A supply mixer 37 as a developer supplying unit is provided in the agitating and supplying chamber 31. The recycled toner mixer 34 is driven by a first motor 38. The fresh toner mixer 36 and the supply mixer 37 are driven by, for example, a developing device motor 40 that drives the developing roller 24. The rotating speed of the developing device motor 40 is variable according to the process speed of the printer 1.

The first motor 38 includes, for example, a stepping motor. The rotating speed of the first motor 38 changes the number of revolutions according to, for example, a detection result of the auto toner sensor for recycled toner 32. The rotating speed of the first motor 38 may change the number of revolutions according to the process speed of the printer 1, a image ratio on the photoconductive drum 11, or a type of an image. When the ratio of the recycled toner in the first developer exceeds a predetermined range in the detection result of the auto toner sensor for recycled toner 32, the rotation of the first motor 38 is controlled to be adjusted. When the ratio of the recycled toner in the first developer is larger than the predetermined range and a recycled toner ratio in the recycled-toner carrying chamber 28 is high, the number of revolutions of the first motor 38 is increased. When the ratio of the recycled toner in the first developer is smaller than the predetermined range and the recycled toner ratio in the recycled-toner carrying chamber 28 is low, the number of revolutions of the first motor 38 is reduced.

The recycled toner mixer 34 agitates and carries a recycled developer, which is the first developer containing the recycled toner and the carrier, in an arrow v direction, i.e., a first direction. The recycled toner mixer 34 supplies the recycled developer agitated and carried in the arrow v direction to the agitating and supplying chamber 31 though the first communicating section 26a and the second communicating section 27a. The fresh toner mixer 36 agitates and carries a fresh developer, which is the second developer containing the fresh toner and the carrier, in an arrow w direction, i.e., a second direction. The fresh toner mixer 36 supplies the fresh developer agitated and carried in the arrow w direction to the agitating and supplying chamber 31 through the second communicating section 27a.

For example, the speed of the recycled toner mixer 34 agitating and carrying the recycled developer is reduced to about ⅙ of the speed of the fresh toner mixer 36 agitating and carrying the fresh developer. Consequently, time for agitation and carrying of the recycled developer by the recycled toner mixer 34 is set longer than time for agitation and carrying of the fresh developer by the fresh toner mixer 36. Therefore, it is possible to give a sufficient charge amount to the recycled toner having low charging properties compared with the fresh toner.

The supply mixer 37 agitates and carries the recycled developer and the fresh developer supplied through the second communicating section 27a in an arrow x direction and supplies the recycled developer and the fresh developer to the developing roller 24. The developers passing through the developing roller 24 is supplied to the fresh-toner carrying chamber 30 from the third communicating section 27b and circulated and carried between the agitating and supplying chamber 31 and the fresh-toner carrying chamber 30.

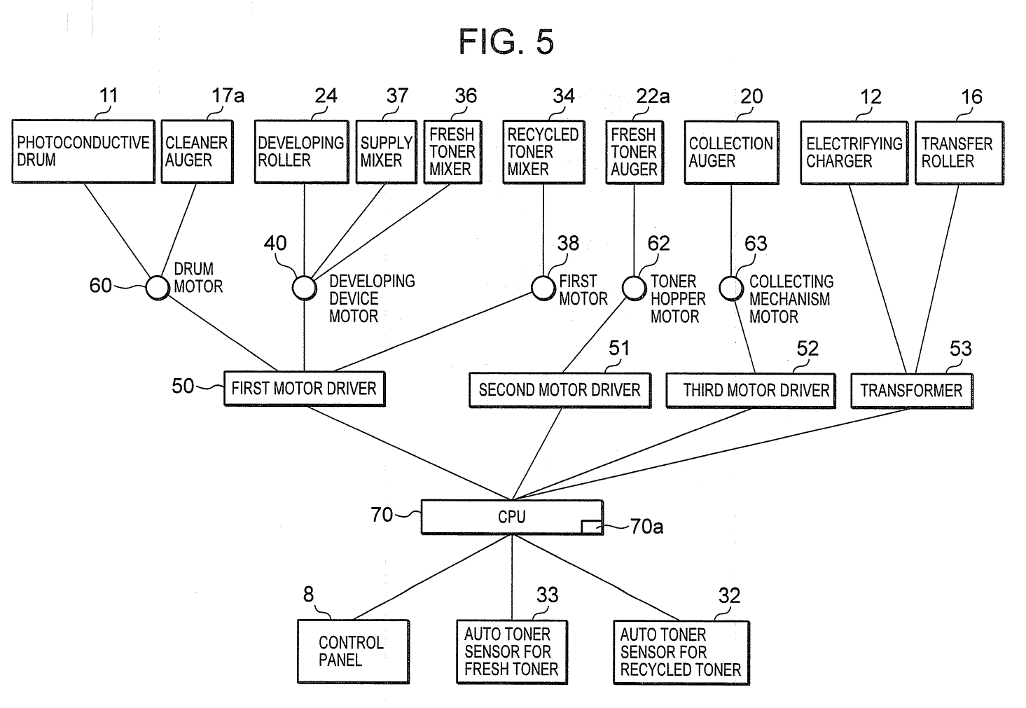

A block diagram of a control system 100 of the printer 1 is shown in FIG. 5. A memory 70a of a CPU 70 as a control unit that controls the printer 1 has, as a table, the numbers of revolutions of the first motor 38 corresponding to detection results of the auto toner sensor for recycled toner 32. The memory 70a also has, as tables, for example, the numbers of revolutions of the first motor 38 corresponding to the process speeds of the printer 1, the numbers of revolutions of the first motor corresponding to image ratios during an image forming process, the numbers of revolutions of the first motor corresponding to whether formed images are text information or picture information.

The control panel 8, the auto toner sensor for recycled toner 32, and the auto toner sensor for fresh toner 33 are connected to an input side of the CPU 70. First to third motor drivers 50, 51, and 52 and a transformer 53 are connected to an output side of the CPU 70. The first motor driver 50 controls a drum motor 60 that drives the photoconductive drum 11 and the cleaner auger 17a. The first motor driver 50 controls the developing device motor 40 that drives the developing roller 24, the supply mixer 37, and the fresh toner mixer 36. The first motor driver 50 controls the first motor 38 that drives the recycled toner mixer 34.

The second motor driver 51 controls a toner hopper motor 62 that drives a fresh toner auger 22a that supplies the fresh toner in the toner hopper 22. The third motor driver 52 controls a collecting mechanism motor 63 that drives the collection auger 20 of the collecting mechanism 18. The transformer 53 controls the electrifying charger 12 and the transfer roller 16.

While the printer 1 carries out an image forming process, the recycled toner removed from the photoconductive drum 11 by the cleaning device 17 is sequentially supplied into the first developer in the recycled-toner carrying chamber 28 from the recycled-toner supply port 28a of the developing device 14 by the collecting mechanism 18. The recycled toner supplied into the first developer is agitated with a carrier and charged while being carried in the arrow v direction at predetermined speed by the recycled toner mixer 34. The first developer that reaches a rear side of the recycled-toner carrying chamber 28 is supplied to the agitating and supplying chamber 31 through the first communicating section 26a and the second communicating section 27a.

When a detection result of the auto toner sensor for fresh toner 33 is equal to or smaller than a predetermined range in the fresh-toner carrying chamber 30 of the developing device 14, the fresh toner in the toner hopper 22 is supplied to the fresh-toner carrying chamber 30. The fresh toner is supplied into the second developer in the fresh-toner carrying chamber 30 from the fresh-toner supply port 30a of the developing device 14 by the fresh toner auger 22a. The fresh toner supplied into the second developer is agitated with a carrier and charged while being carried in the arrow w direction by the fresh toner mixer 36. The fresh toner mixer 36 is driven by the developing device motor 40 and rotated at predetermined speed that is set according to the first process speed or the second process speed. The second developer that reaches a rear side of the fresh-toner carrying chamber 30 is supplied to the agitating and supplying chamber 31 through the second communicating section 27a.

Thereafter, the first developer and the second developer are agitated and carried in the arrow x direction by the supply mixer 37 in the agitating and supplying chamber 31 and supplied to the developing roller 24. A toner is supplied to the photoconductive drum 11. The supply mixer 37 and the developing roller 24 are driven by the developing device motor 40 and rotated at predetermined speed that is set to the first process speed or the second process speed.

During an image forming process, the recycled toner collected by the cleaning device 17 is sequentially supplied in the developing device 14. However, an amount of the recycled toner supplied from the cleaning device 17 to the developing device 14 is different depending on a state of the image forming process carried out in the printer 1. For example, when the image forming process is performed at the high second process speed, when toner density of an image formed on the photoconductive drum 11 is high, or when the image formed on the photoconductive drum 11 is not a text image but a picture image, the amount of the recycled toner increases.

Therefore, in this embodiment, when the amount of the recycled toner supplied to the recycled-toner carrying chamber 28 increases, the recycled toner is discharged to the agitating and supplying chamber 31 side at high speed. In order to discharge the recycled toner to the agitating and supplying chamber 31 side at high speed, the number of revolutions of the recycled toner mixer 34 is increased. Charging properties of the recycled toner are prevented from falling by discharging the recycled toner to the agitating and supplying chamber 31 side at high speed.

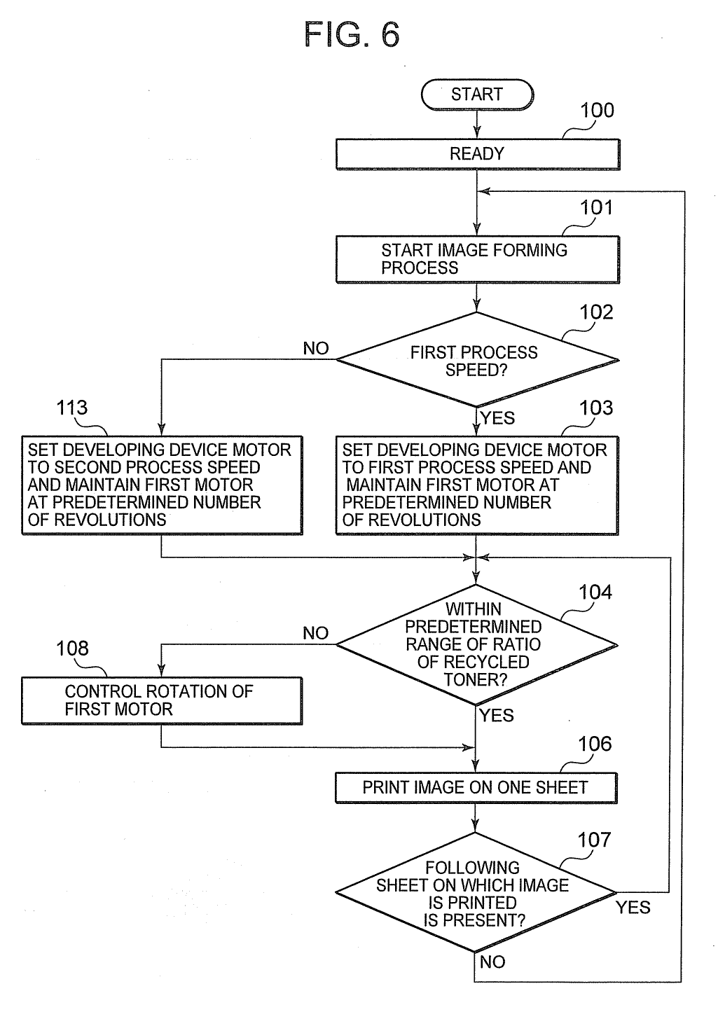

An example of the control of the recycled toner mixer 34 is explained according to a flowchart shown in FIG. 6. After an image forming process is started, in a ready state of the image forming apparatus 10 (Act 100), the user presses a print button to start an image forming process (Act 101). The CPU 70 determines whether process speed is the first process speed (Act 102). When the first process speed is selected, for example, on the control panel 8 (Yes in Act 102), the CPU 70 sets the printer 1 to the first process speed. In the developing device 14, the CPU 70 sets the rotation of the developing device motor 40 to the first process speed. The CPU 70 maintains the first motor 38 at a predetermined number of revolutions (Act 103).

When the second process speed is selected, for example, on the control panel 8 in Act 102 (No in Act 102) the CPU 70 sets the printer 1 to the second process speed. In the developing device 14, the CPU 70 sets the rotation of the developing device motor 40 to the second process speed. The CPU 70 maintains the first motor 38 at a predetermined number of revolutions (Act 113).

After setting the printer 1 to desired process speed in Act 103 or Act 113, when a ratio of the recycled toner in the first developer is within the predetermined range in a detection result of the auto toner sensor for recycled toner 32 (Yes in Act 104), the CPU 70 prints an image on one sheet (Act 106). If there is the following sheet on which the image is printed (Yes in Act 107), the CPU 70 returns to Act 104 and continues a copy operation. When printing on all sheets is finished (No in Act 107), the CPU 70 returns to Act 101 and stands by for the next image forming process.

When the detection result of the auto toner sensor for recycled toner 32 exceeds the predetermined range (No in Act 104), the CPU 70 controls the number of revolutions of the first motor 38 (Act 108). The recycled toner ratio in the recycled-toner carrying chamber 28 rises, for example, when process speed is high, a image ratio of an image is high, or the image is a picture image. When the recycled toner ratio in the recycled-toner carrying chamber 28 rises and the detection result of the auto toner sensor for recycled toner 32 exceeds the predetermined range (No in Act 104), the CPU 70 controls, referring to the table of the memory 70a, the number of revolutions of the first motor 38 to increase and returns to Act 106.

Consequently, the carrying speed of the first developer in the arrow v direction by the recycled toner mixer 34 is increased. The recycled toner is discharged to the agitating and supplying chamber 31 side from the recycled-toner carrying chamber 28 at high speed. By increasing the carrying speed of the recycled toner mixer 34 to facilitate the discharge of the recycled toner, the recycled toner ratio in the recycled-toner carrying chamber 28 is reduced. Therefore, the recycled toner is sufficiently charged while the recycled toner is carried in the arrow v direction in the recycled-toner carrying chamber 28. When the recycled toner ratio in the recycled-toner carrying chamber 28 is reduced and the detection result of the auto toner sensor for recycled toner 32 exceeds the predetermined range while printing is performed (No in Act 104), the CPU 70 controls, referring to the table of the memory 70a, the number of revolutions of the first motor 38 to decrease and returns to Act 106. When the toner ratio of the developer supplied to the developing roller 24 falls in a detection result of the auto toner sensor for fresh toner 33, the CPU 70 supplies the fresh toner from the toner hopper 22.

According to the first embodiment, the CPU 70 controls the carrying speed of the recycled toner mixer 34 according to the ratio of the recycled toner in the first developer in the recycled-toner carrying chamber 28. Consequently, when the ratio of the recycled toner in the first developer rises, it is possible to increase the carrying speed of the recycled toner mixer 34 and discharge the recycled toner from the recycled-toner carrying chamber 28 at high speed. Therefore, even when an amount of the recycled toner collected by the cleaning device 17 is large, it is possible to prevent the ratio of the recycled toner in the first developer from rising in the recycled-toner carrying chamber 28. As a result, it is possible to sufficiently charge the recycled toner in the recycled-toner carrying chamber 28, improve development performance by the developing roller 24, and obtain a satisfactory developed image without fog.

A second embodiment of the present invention is explained. The second embodiment is different from the first embodiment in the control of the recycled toner mixer 34. In this embodiment, the number of revolutions of the first motor 38 is controlled according to the process speed of the printer 1. In this embodiment, when a ratio of the recycled toner in the first developer rises to exceed a threshold, the number of revolutions of the first motor 38 is controlled to be increased. Otherwise, the second embodiment is the same as the first embodiment. Components same as those explained in the first embodiment are denoted by the same reference numerals and signs and detailed explanation of the components is omitted.

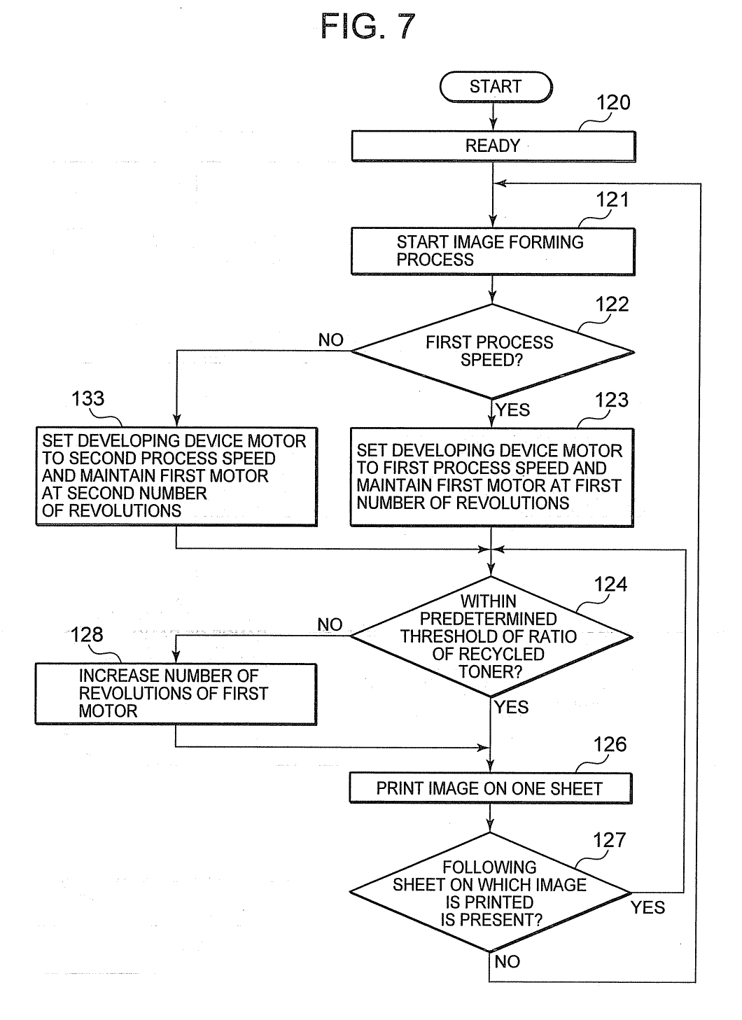

An example of the control of the recycled toner mixer 34 according to the second embodiment is explained with reference to a flowchart shown in FIG. 7. After an image forming process is started, in a ready state of the image forming apparatus 10 (Act 120), a user presses the print button to start an image forming process (Act 121). The CPU 70 determines whether process speed is the first process speed (Act 122). When the first process speed is selected, for example, on the control panel 8 (Yes in Act 122), the CPU 70 sets the image forming apparatus 10 to the first process speed. In the developing device 14, the CPU 70 sets the rotation of the developing device motor 40 to the first process speed. The CPU 70 sets, referring to the table of the memory 70a, the first motor 38 to a first number of revolutions suitable for the first process speed (Act 123).

When the second process speed is selected, for example, on the control panel 8 in Act 122 (No in Act 122), the CPU 70 sets the image forming apparatus 10 to the second process speed. In the developing device 14, the CPU 70 sets the rotation of the developing device motor 40 to the second process speed. The CPU 70 sets the first motor 38 to a second number of revolutions suitable for the second process speed (Act 133). Consequently, it is possible to improve recycled toner discharge ability of the recycled toner mixer 34 in advance before the ratio of the recycled toner in the first developer in the recycled-toner carrying chamber 28 rises.

After setting the printer 1 to desired process speed in Act 123 or Act 133, when a ratio of the recycled toner in the first developer is within the predetermined threshold in a detection result of the auto toner sensor for recycled toner 32 (Yes in Act 124), the CPU 70 prints an image on one sheet (Act 126). If there is the following sheet on which the image is printed (Yes in Act 127), the CPU 70 returns to Act 124 and continues a copy operation. When printing on all sheets is finished (No in Act 127), the CPU 70 returns to Act 121 and stands by for the next image forming process.

When the detection result of the auto toner sensor for recycled toner 32 exceeds the predetermined threshold because, for example, a image ratio of an image is higher or the image is a picture image (No in Act 124), the CPU 70 increases the number of revolutions of the first motor 38 (Act 128) and returns to Act 126. Consequently, the carrying speed of the first developer in the arrow v direction by the recycled toner mixer 34 is increased. The recycled toner is discharged to the agitating and supplying chamber 31 from the recycled-toner carrying chamber 28 at high speed. The recycled toner ratio in the recycled-toner carrying chamber 28 is reduced. Therefore, the recycled toner is sufficiently charged while being carried in the arrow v direction in the recycled-toner carrying chamber 28.

According to the second embodiment, as in the first embodiment, when the ratio of the recycled toner in the first developer is high, the carrying speed of the recycled toner mixer 34 is increased to discharge the recycled toner from the recycled-toner carrying chamber 28 at high speed. This prevents the recycled toner ratio in the recycled-toner carrying chamber 28 from rising. Moreover, the carrying speed of the recycled toner mixer 34 is controlled to be adjusted in advance according to the image forming process speed of the printer 1. Therefore, when an amount of the recycled toner collected by the cleaning device 17 is large, it is possible to prevent in advance the recycled toner ratio in the recycled-toner carrying chamber 28 from rising. As a result, it is possible to sufficiently charge the recycled toner, improve development performance by the developing roller 24, and obtain a satisfactory developed image without fog.

The present invention is not limited to the embodiments described above and can be changed in various ways without departing from the scope of the present invention. For example, the toner recycling device can be applied to a color printer and the like. The control of the first carrying unit by the control unit is arbitrary. For example, in the second embodiment, when the image forming process is started, the carrying speed of the first carrying unit may be controlled according to an image ratio or a type of an image selected on the control panel 8.

What is claimed is:

1. A developing device comprising:
a developing roller opposed to an image bearing member having an electrostatic latent image formed thereon;
a first toner carrying unit that carries a first developer containing a recycled toner collected from the image bearing member and a carrier in a first direction;
a second toner carrying unit that carries a second developer containing a fresh toner and a carrier in a second direction;
a developer supplying unit that agitates the first developer and the second developer and supplies the agitated developer to the developing roller; and
a control unit that controls carrying speed of the first toner carrying unit.

2. The device according to claim 1, wherein the control unit increases the carrying speed of the first toner carrying unit when a toner ratio of the first developer is high.

3. The device according to claim 2, further comprising a toner-ratio detecting unit that detects a toner ratio of the first developer.

4. The device according to claim 1, wherein the control unit increases the carrying speed of the first toner carrying unit when the recycled toner collected from the image bearing member increases.

5. The device according to claim 1, wherein the control unit increases the carrying speed of the first toner carrying unit when an image ratio of a toner image formed on the image bearing member is high.

6. The device according to claim 1, wherein the control unit increases the carrying speed of the first toner carrying unit when a toner image formed on the image bearing member is a picture image.

7. The device according to claim 1, wherein the control unit increases the carrying speed of the first toner carrying unit when traveling speed of the image bearing member is increased.

8. The device according to claim 1, wherein the first toner carrying unit is driven by a first motor and the second toner carrying unit is driven by a second motor.

9. An image forming apparatus comprising:
an image bearing member;
a transfer unit that transfers a toner image on the image bearing member onto a recording medium;
a cleaning unit that collects a toner from the image bearing member;
a developing roller that supplies the toner to an electrostatic latent image formed on the image bearing member;
a recycled-toner supplying unit that supplies a recycled toner collected by the cleaning unit to a developing device main body that houses the developing roller;
a fresh-toner supplying unit that supplies a fresh toner to the developing device main body;
a first toner carrying unit that carries a first developer containing the supplied recycled toner and a carrier in a first direction in the developing device main body;
a second toner carrying unit that carries a second developer containing the supplied fresh toner and a carrier in a second direction in the developing device main body;
a developer supplying unit that agitates the first developer and the second developer and supplies the agitated developer to the developing roller; and
a control unit that controls carrying speed of the first toner carrying unit.

10. The apparatus according to claim 9, wherein the control unit increases the carrying speed of the first toner carrying unit when a toner ratio of the first developer is high.

11. The apparatus according to claim 9, wherein the control unit increases the carrying speed of the first toner carrying unit when the recycled toner supplied by the recycled-toner supplying unit increases.

12. The apparatus according to claim 9, wherein the control unit increases the carrying speed of the first toner carrying unit when the traveling speed of the image bearing member increases.

13. The apparatus according to claim 9, wherein the control unit increases the carrying speed of the first toner carrying unit when an image ratio of a toner image formed on the image bearing member is high.

14. The apparatus according to claim 9, wherein the transfer unit is a transfer roller that comes into contact with the recording medium and transfers the toner image on the image bearing member onto the recording medium.

15. A developing method comprising:
carrying a first developer containing a recycled toner collected from an image bearing member and a carrier in a first direction at carrying speed corresponding to a toner ratio of the first developer;
carrying a second developer containing a fresh toner and a carrier in a second direction;
agitating the first developer and the second developer and supplying the agitated developer to a developing roller; and
developing a electrostatic latent image on the image bearing member.

16. The method according to claim 15, further comprising increasing the carrying speed of the first developer in the first direction when the toner ratio of the first developer is high.

17. The method according to claim 15, further comprising increasing the carrying speed of the first developer in the first direction when the recycled toner increases.

18. The method according to claim 15, further comprising increasing the carrying speed of the first developer in the first direction when an image ratio of a toner image formed on the image bearing member is high.

19. The method according to claim 15, further comprising increasing the carrying speed of the first developer in the first direction when a toner image formed on the image bearing member is a picture image.

20. The method according to claim 15, further comprising increasing the carrying speed of the first developer in the first direction when traveling speed on the image bearing member increases.
